(19) United States
(12) Patent Application Publication
(10) Pub. No.: US 2018/0339193 A1
(43) Pub. Date: Nov. 29, 2018

(54) Grip Strength Trainer with an Integrated Stapler

(71) Applicant: Linfung Co, Seattle, WA (US)

(72) Inventor: Linfung Co, Seattle, WA (US)

(21) Appl. No.: 15/969,390

(22) Filed: May 2, 2018

Related U.S. Application Data
(60) Provisional application No. 62/511,160, filed on May 25, 2017.

(51) Int. Cl. A63B 23/16; B25C 5/02; A63B 21/045; A63B 21/02; A63B 21/04; A63B 21/00

(52) U.S. Cl. CPC A63B 23/16; B25C 5/0285; A63B 21/045; B25C 5/1665; A63B 21/0421; A63B 21/4035; A63B 21/023

(57) ABSTRACT

A grip strength trainer with an integrated stapler uses a finger grip and a grip-engagement mechanism to enable a user to selectively staple documents or train grip strength. The stapler has a base and a top cover that are hingedly, and terminally, connected about a pin. So that the stapler can perform stapling and strength training operations by pivoting the top cover toward the base. The finger grip is mounted onto the base, opposite to the top cover so that the user is able to establish a stable grip. The grip-engagement mechanism is a spring-loaded actuation system that enables the user to select between performing stapling and strength training operations. The grip-engagement mechanism has a mode-switching slot that passes through the finger grip and forms the track along which a mode-control lever travels. The mode control lever enables the user to selectively perform stapling or strength training operations.

The current application claims a priority to the U.S. Provisional Patent application Ser. No. 62/511,160 filed on May 25, 2017.

### FIELD OF THE INVENTION

The present invention relates generally to a stapler. More specifically, the present invention relates to a stapler with an integrated grip strength training device.

### BACKGROUND OF THE INVENTION

From administrative work to construction, staplers have become indispensable tools for getting things done. While staplers can be used for many tasks, one most often encounters staplers in an office environment. Additionally, the ubiquity of staplers provides an incentive to develop staplers that are capable of performing multiple functions. Further, because of the amount of time an adult typically spends in the office there is an incentive to develop a device that enables adults to remain physically fit while working.

The present invention is a device that provides a stapler with an integrated grip strength trainer. This combination enables a user to perform exercises while at a desk. Additionally, the present invention enables the user to selectively transition between stapling documents and performing grip strength training exercises. Specifically, the present invention accomplishes this by providing an ergonomic device that includes a grip-engagement mechanism. The user is able to actuate the grip-engagement mechanism to transition between a stapler mode and a strength trainer mode. Further, a hand grip is used to train the strength of the hand. Its structure is compact, and it is convenient for use. Because of the compact structure, hand grips can be used to train hand muscles in various environments. Despite this benefit, hand grips are often seen as out of place in an office environment. The present invention addresses these issues by providing a stapler that is capable of functioning as a hand grip.

### SUMMARY OF THE INVENTION

The primary object of the present invention is to provide a stapler capable of functioning as a hand grip. A base of the stapler is directly connected with a grip portion. The grip portion and an upper cover of the stapler jointly constitute a hand grip structure. In this way, the stapler not only keeps the same sophisticated appearance but also has the functions of the stapler and the hand grip, so it is more practical.

In order to achieve the aforesaid object, the stapler capable of functioning as a hand grip of the present invention comprises a stapler body and a grip portion. The stapler body has an upper cover, a staple cartridge, and a base. The upper cover, the staple cartridge and the base are pivotally connected together from top to bottom. A first elastic member is perpendicularly provided between the upper cover and the base close to a position where the upper cover and the base are pivotally connected. The grip portion is fixed to a bottom of the base. A second elastic member is provided inside the grip portion. A distal end of the grip portion is provided with an L-shaped groove and a hook ring. The hook ring is movable in the L-shaped groove. One end of the second elastic member is fixed in the grip portion, and another end of the second elastic member is connected to the hook ring. When the grip portion is applied with a force, the grip portion can be elastically opened and closed relative to the stapler body.

In a preferred embodiment, a wavy surface is provided on an outside of the grip portion for stable holding. The first elastic member is a conical compression spring. The second elastic member is a tension spring. The L-shaped groove has a longitudinal positioning groove and a transverse slide groove. When the hook ring is located in the longitudinal positioning groove, the stapler has a stapler function. When the hook ring is located in the transverse slide groove, the stapler has a hand grip function.

### BRIEF DESCRIPTION OF THE DRAWINGS

FIG. 1 is a perspective view of the present invention with the components of the stapler splayed out around the pin.

FIG. 2 is a front view of the present invention.

FIG. 3 is a left-side sectional view of the present invention taken along line 3-3 in FIG. 2.

FIG. 4 is a left-side view of the present invention with the components of the stapler splayed out around the pin.

FIG. 5 is left-side view of the present invention in the engaged configuration.

FIG. 6 is left-side view of the present invention in the disengaged configuration.

FIG. 7 is a bottom perspective view of the top cover used in the present invention.

FIG. 8 is a perspective view of the present invention.

### DETAIL DESCRIPTIONS OF THE INVENTION

All illustrations of the drawings are for the purpose of describing selected versions of the present invention and are not intended to limit the scope of the present invention.

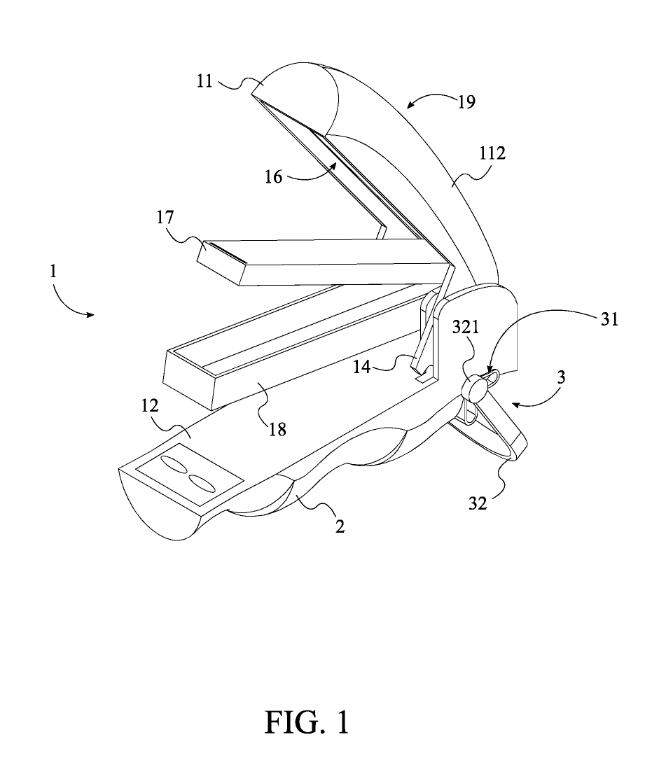

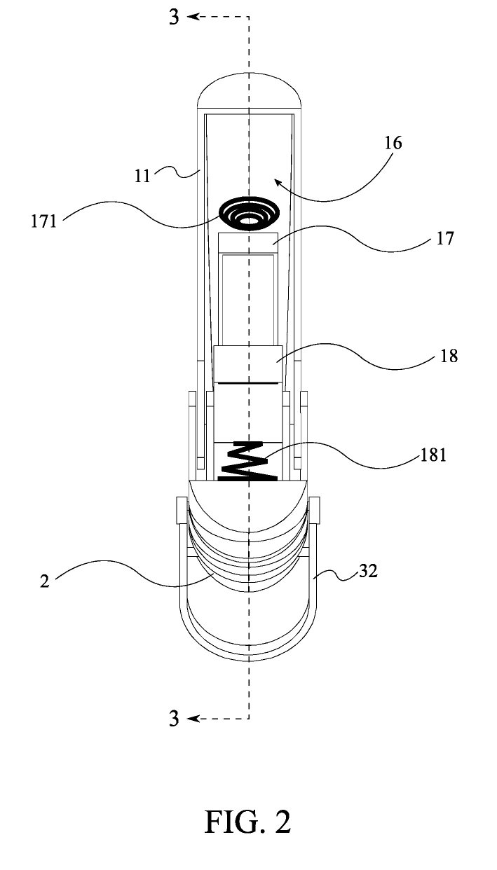

Referring to FIG. 1 through FIG. 8, the present invention, the grip strength trainer with an integrated stapler, is a multi-purpose device that enables a user to easily switch between office-related and physical fitness tasks. To accomplish this, the present invention is designed to be a stapler with a disengageable resistance mechanism. The disengageable resistance member, resists compression of the stapler while engaged. Thus, enabling the present invention to function as a grip strength trainer. Conversely, the disengageable resistance member does not resist compression of the stapler while disengaged. Thus, enabling the present invention to function as a stapler, unimpeded.

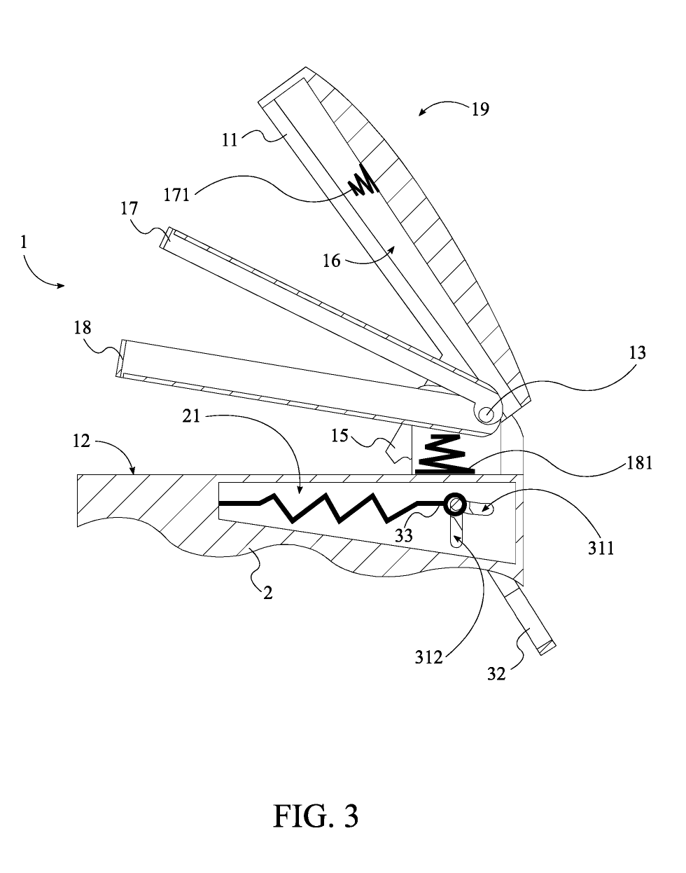

Referring to FIG. 1 and FIG. 3, to achieve the above-describes functionalities, the present invention makes use of an ergonomic covering that maximizes the benefit derived from the integration of the disengageable resistance into the stapler. Further, the present invention comprises a stapler 1, a finger grip 2, and a grip-engagement mechanism 3. The finger grip 2 is an ergonomic covering that is shaped to conform to the fingers of the user. The grip-engagement member is a user actuated control system that acts as the disengageable resistance member that transitions the present invention between an engaged and a disengaged configuration. The stapler 1 enables the user to staple papers and documents together. Specifically, the stapler 1 comprises a top cover 11, a base 12 and a pin 13. The top cover 11 functions as a handle of the stapler 1 that includes a carrier and a hammer. The top cover 11 and the base 12 are hingedly and terminally connected about the pin 13. As a result, the base 12 and the top cover 11 are able to pivot about the pin 13 when the user performs stapling operations or strength training operations. The finger grip 2 is mounted onto the base 12, opposite to the top cover 11 so that the user's hand can form a firm and comfortable grasp on the stapler 1. Additionally, the finger grip 2 is positioned to facilitate grip strength training and reduce had fatigue.

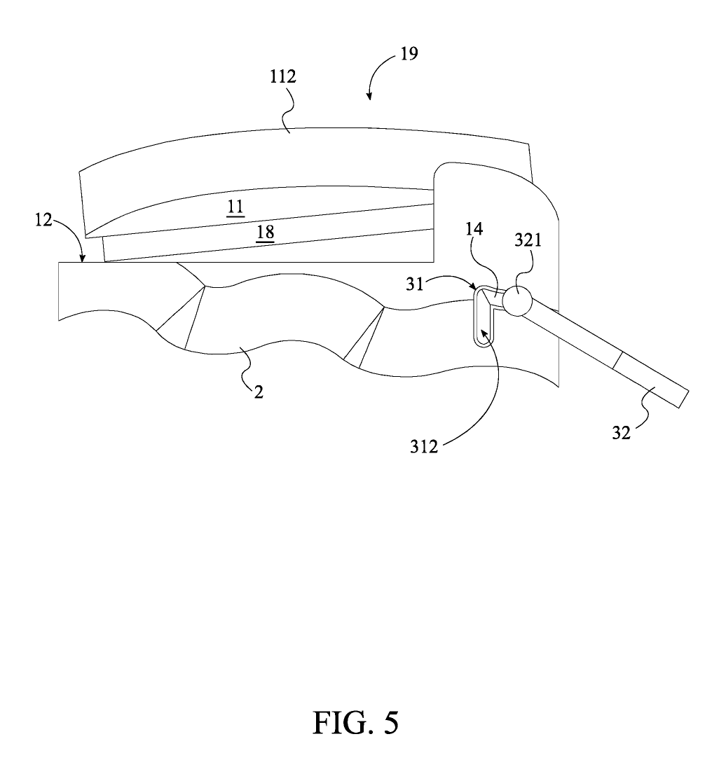

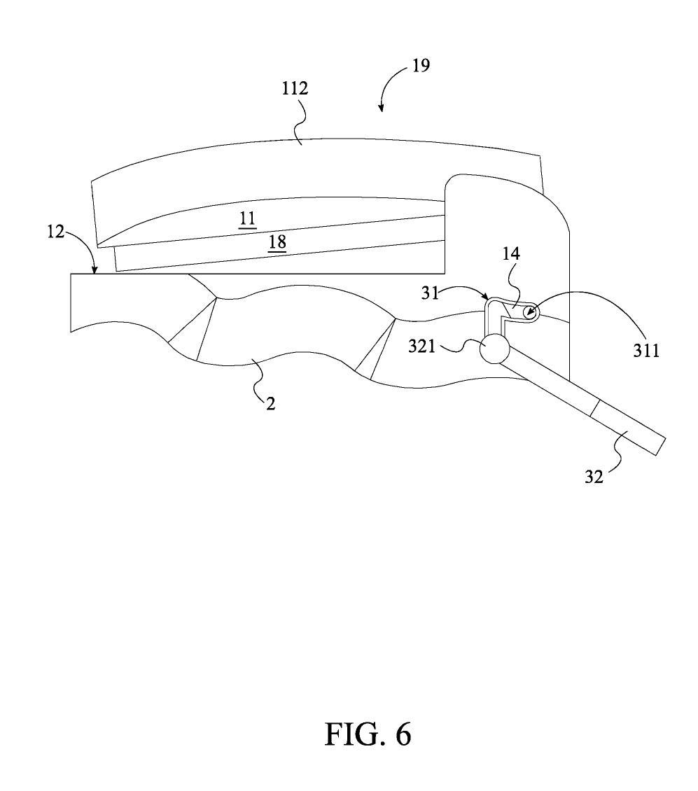

Referring to FIG. 1, FIG. 3, FIG. 5, and FIG. 6, the grip-engagement mechanism 3 is designed to enable the user to easily transition the present invention between a stapler mode and strength trainer mode. To facilitate this, the grip-engagement mechanism 3 comprises a mode-switching slot 31, a mode-control lever 32, and a resistance member 33. The mode-switching slot 31 is a slotted hole that is used to govern the operation of the grip-engagement mechanism 3. To that end, the mode-switching slot 31 traverses through the finger grip 2, parallel to the pin 13. Further, the mode-control lever 32 is slidably engaged within the mode-switching slot 31, between an engaged configuration and a disengaged configuration. Thus engaged, the user is able to reposition the mode-control lever 32 within the mode-switching slot 31 to choose between the stapler mode and strength trainer mode. Specifically, while the mode-control lever 32 is in the engaged configuration, the present invention functions as a grip strength trainer and provides additional resistance to resist compression of the stapler 1. Thus, enabling the user to perform strength training operations. Conversely, while the mode-control lever 32 is in the disengaged configuration, the present invention removes any additional resistance that resists compression of the stapler 1. Thus, enabling the user to perform stapling operations.

Referring to FIG. 1 and FIG. 3, the resistance member 33 is a length-adjustable member that provides a counterforce to compressive forces that are externally applied to the finger grip 2 and the top cover 11. The resistance member 33 can be devices that include, but are not limited to, helical springs, leaf springs, elastic bands, and gas springs. Further, this counterforce is only generated when the mode-control lever 32 is moved into the engaged configuration. To accomplish this, the resistance member 33 is positioned within an interior compartment 21 of the finger grip 2 so that grasping the present invention does not impede the function of the resistance member 33. Additionally, the resistance member 33 is terminally connected to the mode-control lever 32. Further, the resistance member 33 is terminally connected to the finger grip 2, opposite to the mode-control lever 32. As a result, the resistance member 33 is connected in between the mode-control lever 32 and the finger grip 2, such, that the resistance member 33 is stretched whenever the stapler 1 is compressed. Further, the resistance member 33 acts as a linkage that tethers the mode-control lever 32 to the interior compartment 21 without hindering the mode-control lever 32 from transitioning between the engaged configuration and the disengaged configuration.

Referring to FIG. 3 through FIG. 6, the present invention makes use of an arrangement that enables the base 12 and the top cover 11 to function as a hinge with user-controlled resistance characteristics. To that end, the top cover 11 is operatively coupled to the mode-control lever 32, wherein the resistance member 33 generates a force that opposes pivoting the top cover 11 toward the base 12 when the mode-control lever 32 is in the engaged configuration. Consequently, the pivoting motion of the top cover 11 is transformed into linear motion of the resistance member 33. That is, the top cover 11 is designed to abut the mode-control lever 32, such that pivoting the top cover 11 toward the base 12 causes the mode-control lever 32 to be displaced within the mode-switching slot 31. Thus, causing the resistance member 33 to become stretched. Further, the resistance member 33 provides a counterforce that pivots the top cover 11 away from the base 12. Conversely, while in the disengaged configuration, the mode-control lever 32 is moved positioned offset from the top cover 11. As a result, the top cover 11 does not physically touch the mode-switching lever. Thus, the top cover 11 does not displace the mode-control lever 32 within the mode-switching slot 31 when being pivoted toward the base 12. Further, because the top cover 11 does not displace the mode-control lever 32 while in the disengaged configuration, the resistance member 33 is not stretched, and thus does not provide the counterforce required to pivot the top cover 11 away from the base 12.

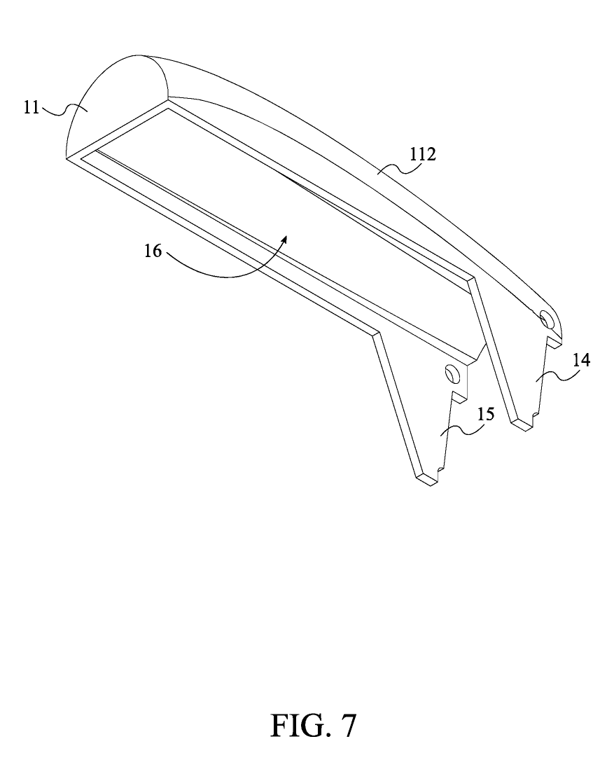

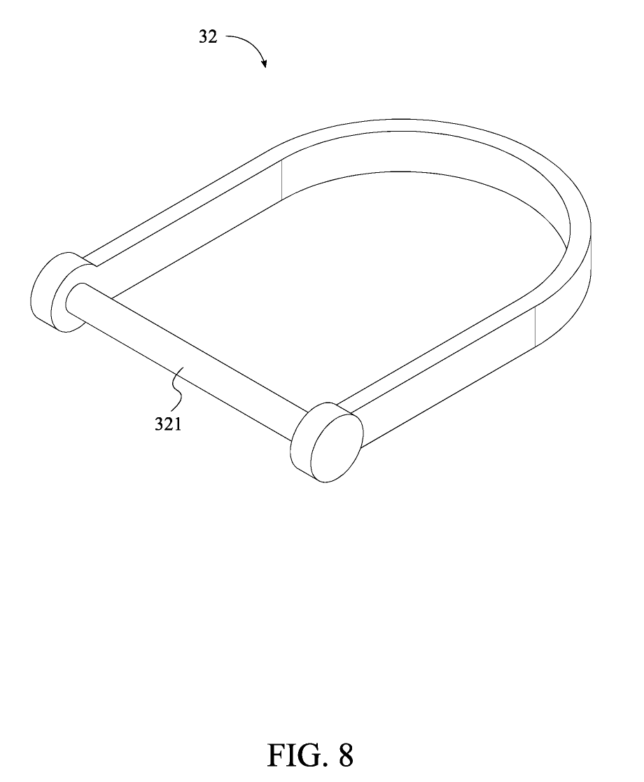

Referring to FIG. 1, FIG. 3, FIG. 7, and FIG. 8, the grip-engagement mechanism 3 works in concert with the top cover 11, to enable the user to selectively transition the present invention between the stapler mode and the strength trainer mode. To achieve this, the stapler 1 further comprises a first force-transfer bracket 14 and a second force-transfer bracket 15. Additionally, the mode-switching slot 31 is an L-shaped slot 31 and the mode-control lever 32 is a D-ring. The first force-transfer bracket 14 and the second force-transfer bracket 15 are rigid protrusions that enable the top cover 11 to actuate, and be actuated by, the mode-control lever 32. To facilitate this, the first force-transfer bracket 14 is laterally connected to the top cover 11. Similarly, the second force-transfer bracket 15 is laterally connected to the top cover 11. Additionally, the first force-transfer bracket 14 is positioned opposite to the second force-transfer bracket 15 across the top cover 11. Thus positioned, the first force-transfer bracket 14 and the second force-transfer bracket 15 are able to evenly distribute the externally applied compression force and the resistance-member-generated counterforce across the body of the top cover 11. Further, the first force-transfer bracket 14 and the second force-transfer bracket 15 are positioned in between the top cover 11 and the base 12. Accordingly, the first force-transfer bracket 14 and the second force-transfer bracket 15 are positioned to abut the mode-control lever 32, when the mode-control lever 32 is in the engaged configuration. Further, a linear bar 321 of the D-ring being slidably engaged within the L-shaped slot 31. As a result, the linear bar 321 is able to slide along a second leg 312 of the L-shaped slot 31 when transitioning between the engaged configuration and the disengaged configuration. Further, the linear bar 321 is able to slide along a first leg 311 of the L-shaped slot 31 when the engaged configuration. This arrangement enables the user to select the stapler mode or the strength trainer mode by sliding the mode-control lever 32 along the second leg 312 of the L-shaped slot 31.

Referring to FIG. 1 and FIG. 3, as described above, the present invention is designed to enable the user to selectively transition between stapling and strength training operations. To that end, the grip-engagement mechanism 3, specifically, the mode-control lever 32, can be transitioned between the engaged configuration and the disengaged configuration. When the mode-control lever 32 is in the engaged configuration the linear bar 321 is slidably engaged along a first leg 311 of the L-shaped slot 31. Additionally, the first force-transfer bracket 14 and the second force-transfer bracket 15 are pressed against the linear bar 321. As a result, compressing the stapler 1 causes the first force-transfer bracket 14 and the second force-transfer bracket 15 to displace the linear bar 321 along the first leg 311 of the L-shaped slot 31. This displacement causes the resistance member 33 generates a counterforce to the compression. Thus, enabling the user to train grip strength. When the mode-control lever 32 is in the disengaged configuration the linear bar 321 is terminally engaged within a second leg 312 of the L-shaped slot 31, opposite to the first leg 311 of the L-shaped slot 31. As a result, the linear bar 321 is slid away from the first force-transfer bracket 14 and the second force-transfer bracket 15. Further, the first force-transfer bracket 14 and the second force-transfer bracket 15 are unable to displace the linear bar 321 when the stapler 1 is compressed. This enables the user to perform stapling operations when the mode-control lever 32 is in the disengaged configuration

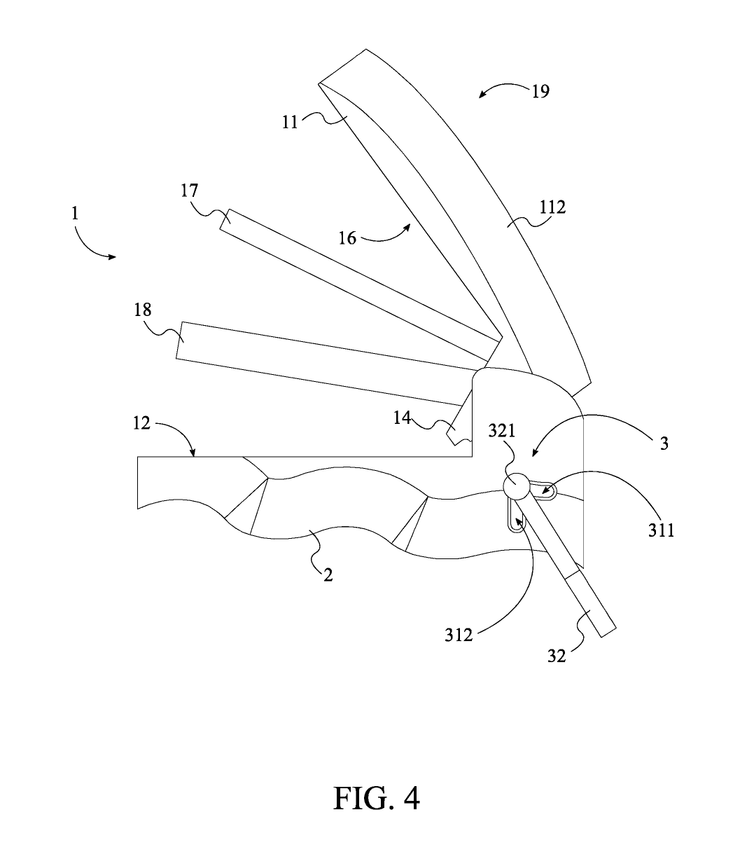

Referring to FIG. 1 and FIG. 4, the present invention is designed to facilitate maintaining a secure grip on the stapler 1 during use. To that end, the stapler 1 further comprises a grip pad 112. The grip pad 112 s a texturized soft membrane that is laterally mounted onto the top cover 11. Additionally, the pad is positioned opposite to the base 12 across the top cover 11. As a result, the grip pad 112 enables the user to form a comfortable and secure hold on the stapler 1. The grip pad 112 is preferably an ergonomically designed device that adds therapeutic benefit to the user.

Referring to FIG. 1 and FIG. 3, the present invention is designed to function as a stapler 1 when the user is not performing strength training operations. To facilitate this, the stapler 1 further comprises a hammer-receiving receptacle 16, a hammer 17, a carrier 18, and a palm-resting surface 19. The palm-resting surface 19 is positioned opposite to the base 12, across the top cover 11 so that the user has an ergonomic surface on which to rest the palm while grasping the present invention. Additionally, the grip pad 112 is superimposed onto the palm-resting surface 19 to further facilitate grasping the present invention. The hammer-receiving receptacle 16 being positioned opposite to the palm-resting surface 19, across the top cover 11. Further, the hammer-receiving receptacle 16 traverses into the top cover 11, toward the palm-resting surface 19. As a result, the hammer-receiving receptacle 16 forms a partial enclosure for the hammer, which facilitates performing stapling operations. The hammer 17 is mounted within the hammer-receiving receptacle 16. Consequently, the hammer 17 is maintained in a position that facilitates driving staples trough the carrier 18 during stapling operations. The carrier 18 is hingedly and terminally connected about the pin 13. As a result, the carrier 18 is able to pivot about the pin 13 independently of the top cover 11. The carrier 18 is positioned in between the hammer 17 and the base 12 so that the hammer 17 is able to drive staples through the carrier 18 during stapling operations.

Referring to FIG. 1 and FIG. 3, the present invention is designed to function as an efficient system that improves the efficiency of stapling operations. To that end, the stapler 1 further comprises a hammer-return spring 171, a carrier-return spring 181, and a locking mechanism 4. The hammer-return spring 171 is connected in between the hammer 17 and the top cover 11. As a result, the hammer-return spring 171 pushes the hammer 17 toward the carrier 18 during stapling operations. The carrier-return spring 181 is connected in between the base 12 and the carrier. As a result, the carrier-return spring 181 pushes the carrier 18 away from the base 12 during stapling operations. Further, the use of the hammer-return spring 171 and the carrier-return spring 181 prevents jamming of the stapler 1 and facilitates performing multiple stapling operations in rapid succession. The locking mechanism 4 is integrated in between the carrier 18 and the base 12. As a result, the carrier 18 can be held in place while the top cover 11 is removed. Thus, facilitating refilling the carrier 18 with staples.

Although the invention has been explained in relation to its preferred embodiment, it is to be understood that many other possible modifications and variations can be made without departing from the spirit and scope of the invention as hereinafter claimed.

What is claimed is:

1. A grip strength trainer with an integrated stapler comprising:
a stapler;
a finger grip;
a grip-engagement mechanism;
the stapler comprising a top cover, a base, and a pin;
the grip-engagement mechanism comprising a mode-switching slot, a mode-control lever, and a resistance member;
the top cover and the base being hingedly and terminally connected about the pin;
the finger grip being mounted onto the base, opposite to the top cover;
the mode-switching slot traversing through the finger grip, parallel to the pin;
the mode-control lever being slidably engaged within the mode-switching slot, between an engaged configuration and a disengaged configuration;
the resistance member being positioned within an interior compartment of the finger grip;
the resistance member being terminally connected to the mode-control lever;
the resistance member being terminally connected to the finger grip, opposite to the mode-control lever;
the top cover being operatively coupled to the mode-control lever, wherein the resistance member generates a force that opposes pivoting the top cover toward the base when the mode-control lever is in the engaged configuration;

2. The grip strength trainer with an integrated stapler as claimed in claim 1 comprising:
the stapler further comprising a first force-transfer bracket and a second force-transfer bracket;
the mode switching slot being an L-shaped slot;
the mode-control lever being a D-ring;
the first force-transfer bracket being laterally connected to the top cover;
the second force-transfer bracket being laterally connected to the top cover, opposite to the first force-transfer bracket;
the first force-transfer bracket and the second force-transfer bracket being positioned in between the top cover and the base;
a linear bar of the D-ring being slidably engaged within the L-shaped slot;

3. The grip strength trainer with an integrated stapler as claimed in claim 2 comprising:
wherein the mode-control lever being in the engaged configuration;
the linear bar being slidably engaged along a first leg of the L-shaped slot;
the first force-transfer bracket and the second force-transfer bracket being pressed against the linear bar;

4. The grip strength trainer with an integrated stapler as claimed in claim 2 comprising:
wherein the mode-control lever being in the disengaged configuration;
the linear bar being terminally engaged within a second leg of the L-shaped slot, opposite to a first leg of the L-shaped slot;

5. The grip strength trainer with an integrated stapler as claimed in claim 1 comprising:
The stapler further comprising a grip pad;
the grip pad being laterally mounted onto the top cover;
the pad being positioned opposite to the base across the top cover;

6. The grip strength trainer with an integrated stapler as claimed in claim 1 comprising:
the stapler further comprising a hammer-receiving receptacle, a hammer, a carrier, and a palm-resting surface;
the palm-resting surface being positioned opposite to the base, across the top cover;
the hammer-receiving receptacle being positioned opposite to the palm-resting surface, across the top cover;
the hammer-receiving receptacle traversing into the top cover, toward the palm-resting surface;
the hammer being mounted within the hammer-receiving receptacle;
the carrier being hingedly and terminally connected about the pin;
the carrier being positioned in between the hammer and the base;

7. The grip strength trainer with an integrated stapler as claimed in claim 6 comprising:
the stapler further comprising a hammer-return spring and a carrier-return spring;
the hammer-return spring being connected in between the hammer and the top cover;
the carrier-return spring being connected in between the base and the carrier;

8. The grip strength trainer with an integrated stapler as claimed in claim 6 comprising:
the stapler further comprising a locking mechanism;
the locking mechanism being integrated in between the carrier and the base;
